(19) United States
(12) Patent Application Publication
(10) Pub. No.: US 2005/0119445 A1
(43) Pub. Date: Jun. 2, 2005

(54) Polyamino acids and method for producing the same

(76) Inventors: Thomas Geller, Odenthal (DE); Arne Gerlach, Odenthal (DE); Anton Vidal-Ferran, Montbrio del Camp (ES); Hans-Christian Militzer, Odenthal (DE); Reinhard Langer, Tonisvorst (DE)

Correspondence Address: LANXESS CORPORATION, 111 RIDC PARK WEST DRIVE, PITTSBURGH, PA, 15275-1112, US

(21) Appl. No.: 10/504,902

(22) PCT Filed: Feb. 14, 2003
(86) PCT No.: PCT/EP03/01512

(30) Foreign Application Priority Data
Feb. 19, 2002 (DE) 102 06 793.7

(51) Int. Cl. C08G 69/08

(52) U.S. Cl. 528/310

(57) ABSTRACT

The invention relates to polyamino acids, to a method for producing the same and to their use as catalysts for enantioselective epoxidation of α,β-unsaturated enons and α,β-unsaturated sulfones.

The invention relates to polyamino acids, to a method for production thereof, and to the use thereof as catalysts for enantioselective epoxidation.

Chirally nonracemic epoxides are valuable building blocks for producing optically active agents and materials (e.g. a) Bioorg. Med. Chem., 1999, 7, 2145-2156; b) Tetrahedron Lett., 1999, 40, 5421-5424). The greatest attention has been devoted in the literature to the epoxidation method of Julia and Colonna, who were able to show that enantiomer-and diastereomer-enriched polyamino acids (PAA) are able in the presence of aqueous hydrogen peroxide solution and NaOH solution, and of an aromatic or halogenated hydrocarbon as solvent, to catalyze the enantioselective epoxidation of α,β-unsaturated enones (Angew.; Chem., Int. Ed. Eng., 1980, 19, 929-930).

Various methods for producing polyamino acids have been described (e.g. Adcances in Protein Chemistry, 1958, 13, 243-492; Russ. Chem. Rev., 1965, 34, 329; Comprehensive Chemical Kinetics, 1976, 15, 583-637). Most of the methods make use of the principle of random polymerization, in which the n-carboxy anhydrides (NCA) of the appropriate amino acids are reacted with an initiator (e.g. amines, water, alcohols and alkoholates) in an inert solvent (e.g. acetonitrile, dioxane, THF, benzene). This results in a mixture of polyamino acids with various chain lengths, and the main product is seen to be polyamino acid having the chain length calculated from the molecular ratio between NCA and initiator. The polymerizations are usually carried out at room temperature. Examples of polymerizations of NCAs at elevated temperature are, by contrast, rare. Thus, for example, high molecular weight films and fibers have been produced by polymerization of L-alanine-NCA (without explicit addition of initiator) or by polymerization of L-leucine-NCA (atmospheric humidity as initiator) with in boiling benzene (DuPont, 1957, U.S. Pat. No. 2,789,973). The reaction times were stated to be 1-10 days. Ebert et al. have also described the production of very high molecular weight polyamino acids in analogy thereto. In this case, for example, poly-L-leucine with an average molecular weight of 400 000 g/mol was produced by polymerization in benzene (70° C., no explicit addition of initiator), and was investigated for its properties in relation to the production of fibers and sheets (Progr. Colloid & Polymer Sci, 1976, 60, 183-193).

A number of procedures also exist for producing the required N-carboxy anhydrides and are known from the literature (e.g. Rec. Trav. Chim. Pays-Bas, 1954, 73, 347).

However, only certain polyamino acids can be used as catalyst in the Julià-Colonna epoxidation, because the reaction rate which can be achieved, and the possible enantiomeric excess (ee) depend very greatly on the polyamino acid used and the way in which it is produced (e.g. Bioorg. Med. Chem., 1999, 7, 2145-2156, Tetrahedron, 1984, 40, 5207-5211; Chirality, 1997, 9, 198-202). In general, polyamino acids with an average molecular weight of <15 000 g/mol are used. The catalytic activity of the polyamino acid also depends to a high degree on the existing polyamino acid conformation which in turn is crucially influenced by the method of production (e.g. Bull. Chem. Soc. Jpn., 2000, 73, 2115-2121; J. Org. Chem., 1993, 58, 6247-6254, Org. Lett., 2001, 3,683-686; ibit 2001, 3, 3839-3842). The catalysts mostly used currently in the Julià-Colonna epoxidation are D- or L-polyleucine. Other polyamino acids which have been successfully used are, for example, D- and L-neopentylglycine (EP-A 1 006 127) or D- or L-alanine.

Julià found that it is possible to obtain by polymerizing alanine-NCA with n-butylamine a polyamino acid which is able to catalyze the enantioselective epoxidation of enones (Angew., Chem., Int. Ed. Eng., 1980, 19, 929-930). The reaction was carried out at room temperature in acetonitrile and took place within 4 days. After filtration of the polymer and washing with ether it was possible to employ the polymer in the epoxidation. Several variations in this procedure were made by Julià and Colonna (e.g. J. Chem. Soc., Perkin 1, 1982, 1317; Tetrahedron, 1983, 39, 1635; Tetrahedron, 1984, 40, 5207-5211), but the polymerizations carried out at room temperature required a very long reaction time. A further distinct disadvantage of the method of Julià and Colonna was the difficult workup of the polymer. It was possible by using an amino-functionalized polymer (polystyrene) as initiator to produce similarly active polymers which were, however, easier to handle (J. Org. Chem., 1990, 55, 6047-6049). The polymerization took place in this procedure in tetrahydrofuran at room temperature over 40 h. Another procedure for producing polyamino acids (especially poly-L-leucine, pLL) was patented by Ajinomoto Co., Inc. (JP 74 38,995) and used by Flisak et al. in the synthesis of SK&F 104353 (J. Org. Chem., 1993, 58, 6247-6254) . In this method, N-carboxy anhydride was polymerized in the solid state at room temperature with atmospheric humidity (5-10 days). A very high purity of the N-carboxy anhydride used is absolutely necessary for good catalytic activity of the material. The high purity of the produced N-carboxy anhydride is also crucial in the method of Bentley et al. (Chirality, 1997, 9, 198-202). The solvent described for the polymerization in this case is also THF (room temperature, reaction time 3 days).

Besides random polymerization, polyamino acids have also been prepared by elaborate, stepwise polymerization in a peptide synthesizer (using protective group techniques) (e.g. Bull. Chem. Soc. Jpn., 2000, 73, 2115-2121; Tetrahedron Lett., 1998, 39, 9297-9300; WO-A-0194327).

In addition, polyamino acids for the Julià-Colonna epoxidation have been produced by polymerizing N-carboxy anhydrides with amino-substituted polyethylene glycols (e.g. WO-A-0194327). Long polymerization times are required in this case too (several days).

In order to compare the catalytic activity of different polyamino acid preparations, in the literature a standard test system with a polyamino acid as catalyst and trans-chalcome as precursor is used for the development and description of novel methods. The quality of the polyamino acid preparation can be deduced from the reaction rate and the resulting enantiomeric excess (ee).

It is an object of the present invention to provide catalysts and a method for producing the catalysts which do not have the aforementioned disadvantages in the enantioselective epoxidation. Simple and reproducible production of the catalysts is particularly important. A high activity, stability, space-time yields and selectivity of the catalysts is also important.

It has now been found, surprisingly, that a suitable catalyst can be obtained by reacting amino acid N-carboxy anhydride (amino acid-NCA) in aromatic solvents at elevated temperature and in the presence of an initiator.

It has additionally been found, surprisingly, that isolation of the catalyst is considerably simplified when C₁-C₄ alcohol is added to the reaction mixture before the filtration.

The inventive production of the catalyst is explained below.

Production of the catalyst can be described by way of example by the following reaction scheme.

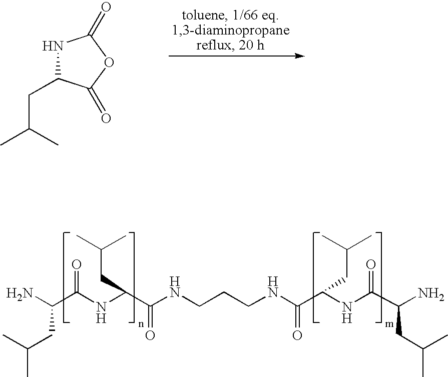

The times for producing the catalyst can be reduced from days to a few hours. It has particularly surprisingly been found that the catalyst produced in this way has a considerably higher catalytic activity than catalyst preparations produced by previously published methods. In addition, the catalyst can be produced in this way in reproducible quality.

The influence of the mode of production on the activity of the catalyst was demonstrated with the aid of the standard test reaction, the polyamino acid-catalyzed epoxidation of trans-chalcone to epoxychalcone (three-phase condition; cf production examples).

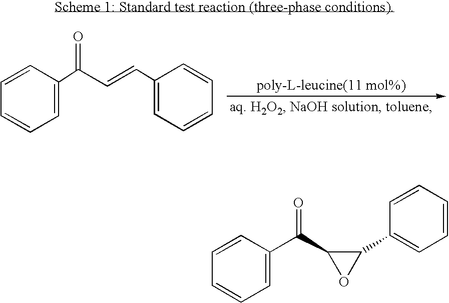

Suitable aromatic solvents are unsubstituted, alkylated, halogenated and initiated benzene derivatives. Those to be emphasized are benzene; nitrobenzene, alkylbenzenes such as toluene, o-, m-, p-xylene, cresol, tetrahydronaphthalene; halobenzenes such as chloro-and dichlorobenzene. Those to be particularly emphasized are benzene, toluene, nitrobenzene and chlorobenzene. Toluene is to be very particularly emphasized. It is possible where appropriate to use solvent mixtures.

Preference is given to aromatic solvents in which precursor and initiator are soluble under the reaction conditions.

The known amino acid-NCAs can be used as starting material for producing the catalyst. Particularly suitable are the amino acid-NCAs described in the above literature for the Julià-Colonna epoxidation. Particular preference is given to D- and L-leucine-NCA, D- and L-alanine-NCA and D- and L-neopentylglycine-NCA. D- or L-leucine-NCA is very particularly preferred.

Production of the amino acid-NCAs is known and can take place in analogy to known methods.

The initial concentration of the amino acid-NCAs can be varied within a wide range. In general, from 0.5 to 25% by mass, preferably 1 to 10% by mass and particularly preferably 1 to 5% by mass of amino acid-NCA are used in the reaction mixture.

Initiators which can be used are the known initiators. In particular monohydric and polyhydric alcohols or salts thereof, and monofunctional and polyfunctional amines, can be used. The following amines are particularly suitable: 1,3-diaminopropane, CLAMPS, n-butylamine, amine-substituted PEG.

The molar ratio of amino acid-NCA to equivalent of initiator can be varied within a wide range and is between 4:1 and 200:1. The ratio is preferably between 4:1 and 100:1; particularly preferably between 4:1 and 50:1, very particularly preferably between 10:1 and 40:1. The ratio varies depending on the initiator used. The average chain length can be influenced for example by the initiator and the ratio of amino acid-NCA to initiator.

The reaction temperature can be varied within a wide range and is between 30° C. and the boiling point of the reaction mixture. The reaction temperature is preferably between 50° C. and the boiling point of the reaction mixture, particularly preferably between 80° C. and 110° C., very particularly preferably between 90° C. to 110° C. The reaction temperature can be varied during the course of the reaction. In one embodiment of the invention, the temperature is increased after the start of the reaction. In an alternative embodiment, the initiator is metered into the boiling solvent, and the reaction mixture is kept at the boiling point throughout the reaction time.

The reaction pressure can be varied within a wide range and is between 0.5 and 5 bar, preferably between 0.9 and 1.5 bar, particularly preferably atmospheric pressure.

The catalyst can be isolated from the reaction mixture by customary laboratory methods. Thus, removal by filtration or centrifugation is possible. The catalyst obtained in this way can then be subjected to further purification and workup steps such as washing and drying. It is advantageous to add a C₁-C₄ alcohol before the filtration or centrifugation. Methanol and ethanol are particularly suitable as C₁-C₄ alcohol. The amounts of added alcohol can be varied within a wide range and is between 0.1:1 and 10:1 (v/v). Preferred ranges are between 0.5:1 and 2:1 (v/v) the ratio 1:1 by volume is particularly preferred.

The inventive use of the catalyst is epoxidation reactions is explained below.

An epoxidation reaction means the conversion of a C—C double bond into an oxirane. In particular, an epoxidation reaction means the conversion of α,β-unsaturated enones or α,β-unsaturated sulfones into the corresponding epoxides.

It is possible to employ as α,β-unsaturated enones or α,β-unsaturated sulfones the compounds of the general formula (II) 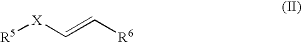
in which
X is (C═O) or (SO₂), and
R⁵ and R⁶ are identical or different and are (C₁-C₁₈)-alkyl, (C₂-C₁₈)-alkenyl, (C₂-C₁₈)-alkynyl, (C₃-C₈)-cycloalkyl, (C₆-C₁₈)-aryl, (C₇-C₁₉)-aralkyl, (C₁-C₁₈)-heteroaryl or (C₂-C₁₉)-heteroaralkyl,
   where the radicals mentioned for R⁵ and R⁶ may be substituted once or more than once by identical or different radicals R⁷, halogen, NO₂, NR⁷R⁸, PO₀₋₃R⁷R⁸, SO₀₋₃R⁷, OR⁷, CO₂R⁷, CONHR⁷ or COR⁷, and optionally one or more CH₂ groups in the radicals R⁵ and R⁶ are substituted by O, SO₀₋₂, NR⁷ or PO₀₋₂R⁷,
   where R⁷ and R⁸ are identical or different and are H, (C₁-C₁₈)-alkyl, (C₂-C₁₈)-alkenyl, (C₂-C₁₈)-alkynyl, (C₃-C₈)-cycloalkyl, (C₆-C₁₈)-aryl, (C₁-C₁₈)-heteroaryl, (C₁-C₈)-alkyl-(C₆-C₈)-aryl, (C₁-C₈)-alkyl-(C₁-C₁₉-heteroaryl, (C₁-C₈)-alkyl-(C₃-C₈)-cycloalkyl radicals R⁷ and R⁸ may be substituted once or more than once by identical or different halogen radicals.

A (C₁-C₁₈)-alkyl radical means for the purposes of the invention a radical having 1 to 18 saturated C atoms and possibly having branches at any positions. It is possible to include in this group in particular the radicals methyl, ethyl, n-propyl, isopropyl, n-butyl, isobutyl, sec-butyl, tert-butyl, pentyl and hexyl.

A (C₂-C₁₈)-alkenyl radical has the features mentioned for. the (C₁-C₁₈)-alkyl radical, but at least one double bond must be present within the radical.

A (C₂-C₁₈)-alkynyl radical has the features mentioned for the (C₁-C₁₈)-alkyl radical, but at least one triple bond must be present within the radical.

A (C₃-C₈)-cycloalkyl radical means a cyclic alkyl radical having 3 to 8 C atoms and optionally a branch in any position. Radicals included herein are in particular cyclopropyl, cyclobutyl, cyclopentyl, cyclohexyl and cycloheptyl. One or more double bonds may be present in this radical.

A (C₆-C₁₈)-aryl radical means an aromatic radical having 6 to 18 C atoms. Radicals included herein are in particular phenyl-, naphthyl-, anthryl- and phenanthryl.

A (C₇-C₁₉)-aralkyl radical means a (C₆-C₁₈)-aryl radical linked via a (C₁-C₈)-alkyl radical to the molecule.

A (C₁-C₁₈)-heteroaryl radical means for the purposes of the invention a five-, six- or seven-membered aromatic ring system having 1 to 18 C atoms and having one or more heteroatoms, preferably N, O or S, in the ring. These heteroaryl radicals include for example 1-, 2-, 3-furyl, 1-, 2-, 3-pyrrol, 1-, 2-, 3-thienyl, 2-,3-, 4-pyridyl, 2-, 3-, 4-, 5-, 6-, 7-indolyl, 3-, 4-, 5-pyrazolyl, 2-, 4-, 5-imidazolyl, 1-, 3-, 4-, 5-triazolyl, 1-, 4-, 5-tetrazolyl, acridinyl, quinolinyl, phenanthridinyl, 2-, 4-, 5-, 6-pyrimidinyl and 4-, 5-, 6-, 7-(1-aza)-indolizinyl.

A (C₂-C₁₉)-heteroaralkyl radical means a heteroaromatic system corresponding to the (C₇-C₁₉)-aralkyl radical.

Halogen or else Hal means in the context of this invention fluorine, chlorine, bromine and iodine.

The amount of polyamino acid employed is not critical and is normally in the region of 0.001-40 mol %, preferably in the region of 0.01-20 mol %, particularly preferably in the region of 0.01-10 mol %, in each case based on the α,β-unsaturated enone or α,β-unsaturated sulfone employed.

### EXAMPLES

1. Preparation of the Starting Material

L-leucine-NCA: 200.0 g (1.52 mol) of L-leucine were introduced into 2000 ml of THF in a standard phosgene apparatus consisting of a 2000 ml four-necked flask with KPG stirrer. Then 514.28 g (5.2 mol) of phosgene were passed in at a temperature of 22-33° C. over the course of 6.5 h. The clear reaction solution was then stirred at room temperature for 16 h. The solvent was then completely distilled off at 35° C. and 80 mbar. The residue was washed with a total of 1800 ml of n-hexane in portions and was dried at room temperature under reduced pressure. Yield: 203.2 g (85%)

2. Preparation of the Catalyst

2.1 Inventive Preparation—Variant A

(leu)₁₀-NH—(CH₂)₃—NH-(leu)₁₀(random mixture, average chain length indicated): 100.0 g (636.25 mmol) of L-leucine-NCA were introduced into 700 ml of anhydrous toluene under argon in a 2 l three-necked flask with fitted reflux condenser (closed with a bubble counter filled with silicone oil) and mechanical stirrer and subsequently heated to 110° C. Then, at 110° C., 2.358 g (31.81 mmol) of 1,3-diaminopropane in 20 ml of anhydrous toluene were slowly and cautiously added dropwise to the rapidly stirred solution. After the initially very extensive evolution of gas had subsided, the reaction mixture was stirred at 110° C. for a further 16 h. The reaction mixture was cooled to room temperature, mixed with 700 ml of methanol and stirred under reflux. The white solid obtained in this was filtered off at room temperature and stirred a second time with 1000 ml of methanol under reflux and filtered off. The polymer isolated in this way was then dried in a vacuum drying oven under reduced pressure (50° C., approx. 15 mbar) overnight. Yield: 67.0 g

2.2 Inventive Preparation—Variant B

(leu)₁₀-NH—(CH₂)₃—NH-(leu)₃₃ (random mixture, average chain length indicated): 38.0 g of L-leucine-NCA were introduced under argon into a 2 l two-necked flask with fitted reflux condenser (closed with a bubble counter filled with silicone oil) and mechanical stirrer and dissolved in 970 ml of anhydrous toluene. At room temperature, 0.272 g of 1,3-diaminopropane (freshly distilled from CaH₂) in 20 ml of anhydrous toluene were added to the rapidly stirred solution. After the initially extensive evolution of gas had subsided, the reaction mixture was slowly heated to reflux and kept at this temperature for 16 h. The reaction mixture was cooled to room temperature and then centrifuged. The polymer isolated in this way was dried under reduced pressure (50° C.-60° C., approx. 15 mbar). Finally, the polymer was powdered in a mortar and again dried over P₂O₅ under reduced pressure. Yield: 25.4 g

2.3 Known Preparation

(cf. Chirality, 1997, 9, 198-202, workup modified)

38 g of L-leucine-NCA were introduced under argon into a 2 l two-necked flask with fitted reflux condenser (closed with a bubble counter filled with silicone oil) and magnetic stirrer and dissolved in 970 ml of anhydrous tetrahydrouran (THF). At room temperature, 0.272 g of 1,3-diaminopropane (freshly distilled from CaH₂) in 20 ml of anhydrous THF were added to the rapidly stirred solution. The reaction mixture was stirred (approx. 400-500 rpm) at room temperature for 5 days. After the reaction time was complete, workup took place in analogy to the procedure described under a).Yield: 24.9 g.

3. Catalytic Reactions

General Epoxidation Procedures

The progress of the epoxidations was monitored by HPLC or TLC, with light being excluded during the epoxidations. Analytical samples were filtered through a membrane filter before the HPLC measurements.

### Example 1

(3-Phase conditions; Chirality, 1997, 9, 198-202, workup modified)

100 mg of pll (not preactivated) were suspended in a mixture of 0.8 ml of toluene, 0.2 ml of NaOH (SM, 4.2 eq.) and 0.2 ml of H₂O₂ (30%, aq.). This mixture was stirred at approx. 1250 rpm for 6 h. Subsequently, 0.24 mmol of trans-chalcone and a further 0.5 ml of H₂O₂ (30%, aq., total=28.5 eq.) were added. After the reaction was complete (or a chosen reaction time), the reaction mixture was diluted with 2 ml of EtOAc and subsequently centrifuged. The supernatant was then slowly introduced into a stirred ice-cold aqueous NaHSO₃ solution (4 ml, 20%). After phase separation, the organic phase was dried (Na₂SO₄) and concentrated under reduced pressure.

| | | Reaction | | |
|---|---|---|---|---|
| No. | Catalyst | time (h) | Conversion (%) | ee (%) |
| 1 | prepared as in 2.1 | 1.5 | 30 | 87 |
| 2 | prepared as in 2.2 | 1.5 | 59 | 91 |
| 3 | prepared as in 2.3 | 1.5 | 2 | not determined |

1. A polyamino acid comprising reacting at least one amino acid-N-carboxy anhydrides with at least one initiator wherein the reacting of the at least one amino acid-N-carboxy anhydride and the at least one initiator is carried out under conditions in which
a) an aromatic solvent is used;
b) the reaction temperature is between 30° C. and the boiling point of the reaction mixture, and
c) the molar ratio of amino acid-NCA to the initiator is between 4:1 and 200:1.

2. A method for producing polyamino acids comprising reacting amino acid-N-carboxy anhydrides with an initiator wherein the reacting of the at least one amino acid-N-carboxy anhydride and the at least one initiator is carried out under conditions in which
a) an aromatic solvent is used;
b) the reaction temperature is between 30° C. and the boiling point of the reaction mixture, and
c) the molar ratio of amino acid-NCA to the initiator is between 4:1 and 200:1.

3. An process comprising converting a C—C double bond of compound into an oxirine, wherein the process is an epoxidation reaction carried out with a polyamino acid catalyst;
wherein the polyamino acid catalyst is made by a process involving reacting at least one amino acid-N-carboxy anhydride with at least one initiator
wherein the reacting of the at least one amino acid-N-carboxy anhydride and the at least one initiator is carried out under conditions in which
a) an aromatic solvent is used:
b) the reaction temperature is between 30° C. and the boiling point of the reaction mixture, and
c) the molar ratio of amino acid-NCA to the initiator is between 4:1 and 200:1.

4. The process of claim 3, wherein the C—C double bond is a C—C double bond of a compound selected from the group consisting of α,β-unsaturated enones, α,β-unsaturated sulfones.

5. The process of claim 4, wherein the ,β-unsaturated enones or α,β-unsaturated sulfones the compounds of the general formula (II) 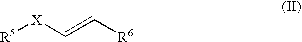
in which
X is (C═O) or (SO₂), and
R⁵ and R⁶ are identical or different and are (C₁-C₁₈)-alkyl, (C₂-C₁₈)-alkenyl, (C₂-C₁₈)-alkynyl, (C₃-C₈)-cycloalkyl, (C₆-C₁₈)-aryl, (C₇-C₁₉)-aralkyl, (C₁-C₁₈)heteroaryl or (C₂-C₁₉)-heteroaralkyl,
wherein the radicals mentioned for R⁵ and R⁶may be substituted once or more than once by identical or different radicals R⁷, halogen, NO₂, NR⁷ R⁸, PO₀₋₃R⁷R⁸, SO₀₋₃R⁷, OR⁷, CO₂R⁷, CONHR⁷ or COR⁷, and optinoally one or more CH₂ groups in the radicals R⁵ and R⁶ are substituted by O, SO₀₋₂, NR⁷ or PO₀₋₂R⁷, wherein R⁷ and R⁸ are identical or different and are H, (C₁-C₁₈)-alkyl, (C₂-C₁₈)-alkenyl, (C₂-C₁₈)-alkynyl, (C₃-C₈)-cycloalkyl, (C₆-C₁₈)-aryl, (C₁-C₁₈)-heteroaryl, (C₁-C₈)-alkyl-(C₆-C₈)-aryl, (C₁-C₈)-alkyl-(C₁-C₁₉)-heteroaryl, (C₁-C₈)-alkyl-(C₃-C₈)-cyocloalkyl, and these radicals R⁷ and R⁸ may be substituted once or more than once by identical or different halogen radicals.
